(19) United States
(12) Patent Application Publication
(10) Pub. No.: US 2007/0055650 A1
(43) Pub. Date: Mar. 8, 2007

(54) Query caching in a system with a content directory service

(75) Inventors: Bruce Duncan, Reading (GB); Dale R. Heron, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/573,555

(22) PCT Filed: Sep. 27, 2004
(86) PCT No.: PCT/IB04/51879

§ 371 Date: Mar. 27, 2006

(30) Foreign Application Priority Data
Sep. 30, 2003 (GB) 0322797.2

(51) Int. Cl. G06F 17/30

(52) U.S. Cl. 707/3

(57) ABSTRACT

A caching device (70) queries (203a) the CDS of a serving device (MS-a) for media content information and stores the results (204a) for later retrieval. The query (203a) can be made in response to receiving a request (202) from a querying device (UI, 21) to perform the query or in response to a query formulated by the caching device itself. The cached results can be accessed by the querying device in preference to re-performing the required query. The cached results can be maintained up-to-date at the request of the querying device (21) or automatically without involvement of the querying device.

This invention relates to systems which use a Content Directory Service (CDS) to store media content information, such as systems which conform to the Universal Plug and Play (UPnP) architecture.

There is an ever increasing use of digital storage devices to store media content. The media content can range from simple text files to multi-media content such as audio, pre-recorded or user-recorded video, broadcast digital audio (e.g. Internet radio)i broadcast digital video or digital images (e.g. digital photos.)

Universal Plug and Play (UPnP) is a communications protocol which allows electronic devices produced by different manufacturers to operate with one another. UPnP is designed to support zero-configuration, “invisible” networking, with automatic discovery of new devices. This means a device can dynamically join a network, obtain an IP address, convey its capabilities, and learn about the presence and capabilities of other devices. A further development of UPnP is the UPnP Audio-Visual (AV) Architecture which describes extensions of the UPnP architecture relevant to Audio-Visual devices. The UPnP AV Architecture defines a Media Server, a Media Renderer and a Control Point.

Many devices within a UPnP compliant network, such as a UPnP home network, contain various types of content that other devices in the network would like to access (e.g. music, videos, still images). As an example, a Media Server device might contain audio, video, and still-image libraries. In order for the user to enjoy this content, the user must be able to browse the objects stored on the Media Server, select a specific one, and cause it to be played on an appropriate rendering device (e.g. an audio player for music objects, a TV for video content, an Electronic Picture Frame for still-images). For maximum convenience, it is desirable to allow the user to initiate these operations from a variety of user interface (UI) devices. In most cases, these UI devices will either be a UI built into the rendering device, or it will be a stand-alone UI device such as a remote control unit, wireless personal digital assistant (PDA) or tablet. It is desirable that a user can access the content without having to interact directly with the device containing the content.

One of the primary parts of the UPnP AV Architecture is the Content Directory Service (CDS). The CDS provides a set of features which allow UPnP Control Point (CP) devices to access the content stored on Media Server (MS) devices. The current publicly available description of CDS is the “Content Directory Service Template Version 1.01” for Universal Plug and Play Version 1.0, Jun. 25, 2002. The Content Directory Service allows clients (e.g., UI devices) to locate individual objects (e.g. songs, movies, pictures) that the server device is capable of providing. For example, this service can be used to provide a list of songs stored on an MP3 player, a list of still-images comprising various slide-shows, a list of movies stored in a DVD Jukebox, a list of TV shows currently being broadcast, a list of songs stored in a CD Jukebox, a list of programs stored on a PVR (Personal Video Recorder) device. Nearly any type of content can be listed via the CDS and multiple types of content (e.g. MP3, MPEG2, JPEG) can be listed together by the CDS.

Content is stored in a hierarchical structure of UPnP container objects, each container having a collection of objects stored within them. Each object includes media content information and a media content locator such as a Uniform Resource Identifier (URI). Although the UPnP AV Working Committee has issued a set of class definitions (see Appendix C of the “Content Directory Service Template Version 1.01” for Universal Plug and Play Version 1.0, Jun. 25, 2002), UPnP does not require a Media Server's CDS to be arranged in a particular way and so the way in which containers and objects are arranged is decided by each vendor or user. Consequently, each CDS can have a unique structure and individual objects within the structure may be labelled with different combinations of descriptive metadata. Additionally, UPnP defines two mechanisms by which a CDS can be inspected by a querying device: a “Browse” mechanism by which a querying device can browse through the CDS structure and a more useful “Search” mechanism by which a querying device can request a CDS to return items meeting specified search terms. However, the “Search” mechanism is optional and it is possible that the CDS hosted by a Media Server does not implement UPnP's optional “Search” functionality but instead requires the CP to “Browse” it's hierarchy on a container-by-container basis.

When a Control Point queries a CDS, there is an inevitable delay before a response is received. This delay includes time taken to search the CDS database for the required information, as well as time taken to collate extracted information. This delay may vary, depending on factors including the type and scale of the search, the performance of individual devices and the efficiency of communication between devices. The delay is further prolonged in situations where the user interface is arranged in a different manner to the CDS of storage devices or where the CDS only supports the ‘browse’ operation. In both cases, the querying device must make multiple queries to extract the required information. Long delays before responses are received, as well as variability in the delays, degrades the user's experience of using the system.

Accordingly, the present invention seeks to provide an improved way of operating a system in which a content directory service is used.

A first aspect of the present invention provides a method of storing query information at a caching device in a system which uses a Content Directory Service (CDS) to store media content information, comprising:
querying the CDS of a serving device for media content information;
receiving the results of the query; and,
storing the results for later retrieval.

By allowing a caching device to perform the query and store the result, the processing and storage resources of the querying device are not burdened with providing a caching service. The stored, or cached, results can be accessed by the querying device in preference to re-performing the required query. This can result in a faster delivery of results which improves the user's experience of interacting with the querying device.

Preferably, the cached results are maintained up-to-date, either at the request of the querying device or automatically without involvement of the querying device. This improves the usefulness of the caching service and further reduces the burden on the resources of the querying device.

Preferably, the service is provided to multiple querying devices in the system.

Preferably, only the most relevant queries are cached. Thus, only a relatively small number of results need to be stored and maintained and the time taken to retrieve a result is reduced, in relation to accessing the CDS directly.

The method can be performed by a device, either for internal use by that device or as a service which can be used by other devices in the system. The method can be hosted by a storage device (such as a UPnP device of the Media Server type) or any other device with processing and storage resources. The method may be hosted by a device which provides another service to devices on the network, and is particularly suited for hosting by any device. which holds knowledge about storage devices on the network.

A further aspect of the invention provides a method of operating a querying device in a system which uses a Content Directory Service (CDS) to store media content information, comprising:
determining a candidate query that should be cached; and,
instructing a caching device to perform the candidate query and to store the results of the query.

Further aspects of the invention provide apparatus for implementing the methods.

The functionality described here can be implemented in software, hardware or a combination of these. Accordingly, another aspect of the invention provides software for performing the method. The software may be stored on an electronic memory device, hard disk, optical disk or other machine-readable storage medium and will be executed by a suitable processing device on the host device. The software may be delivered as a computer program product on a machine-readable carrier or it may be downloaded directly to the host device via a network connection. It will be appreciated that the software may be installed at any point during the life of the host device.

The term ‘Content Directory Service’ (CDS) is intended to include the CDS used in UPnP systems, but it is not to be taken as limited to just UPnP systems. It can include any CDS-like storage system for media content information which has a hierarchical structure that is loosely defined and thus unpredictable and difficult for querying devices to extract required information from.

Embodiments of the present invention will now be described, by way of example only, with reference to the accompanying drawings, in which:

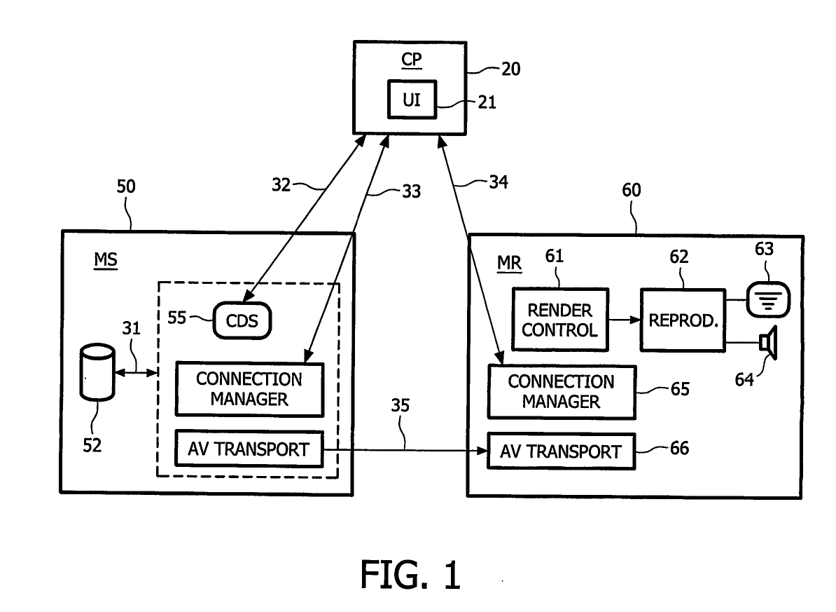

FIG. 1 shows the main components of a UPnP system;

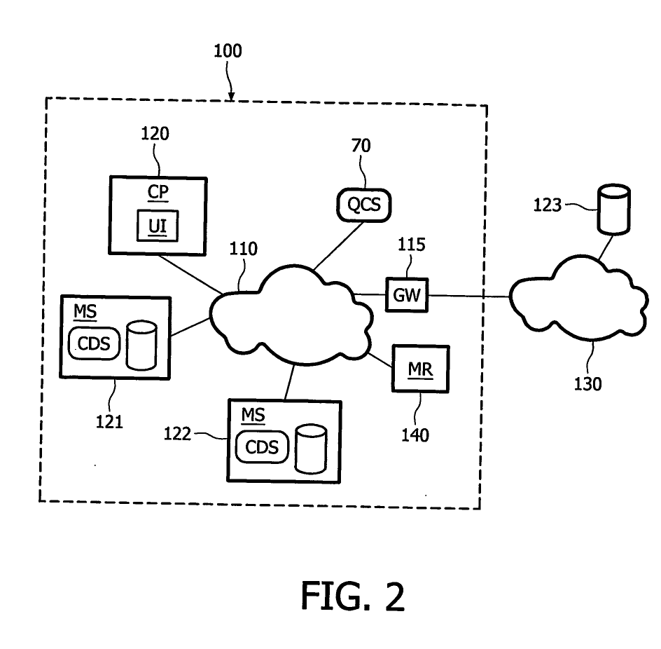

FIG. 2 shows a network of UPnP devices;

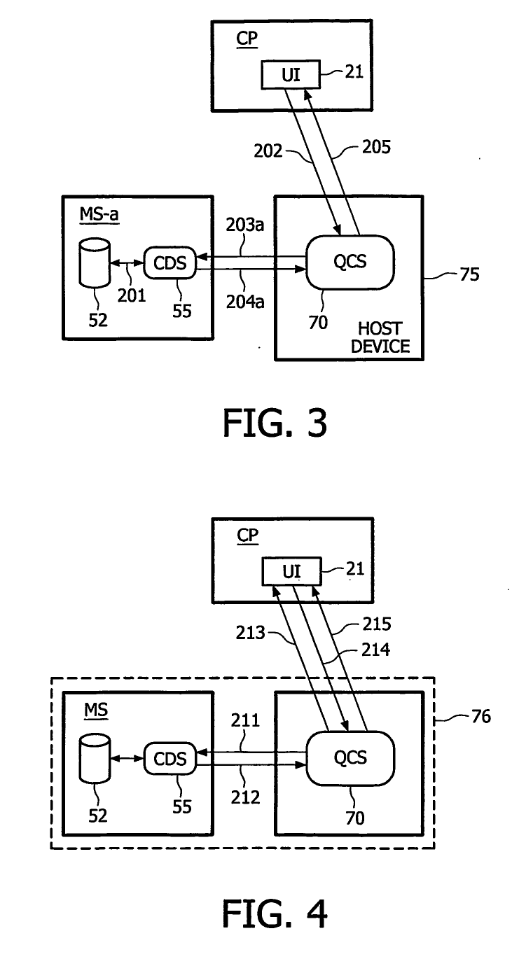

FIGS. 3 to 5 show an embodiment of a system which includes a query caching service in accordance with the invention;

FIG. 6 shows the main functional blocks of the query caching service;

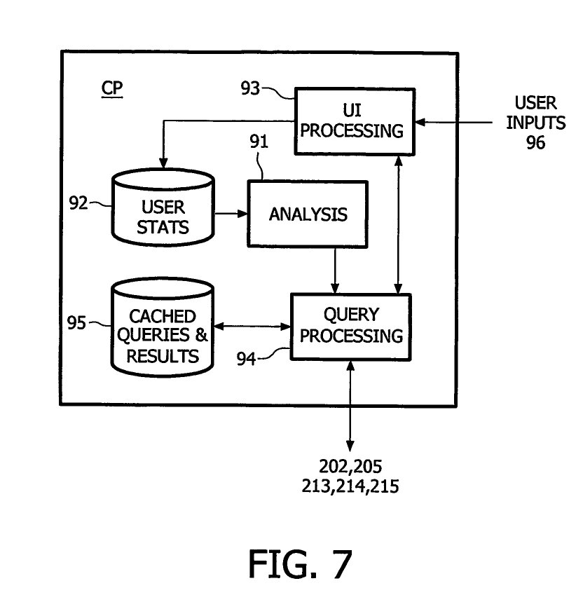

FIG. 7 shows the main functional blocks of a Control Point; and,

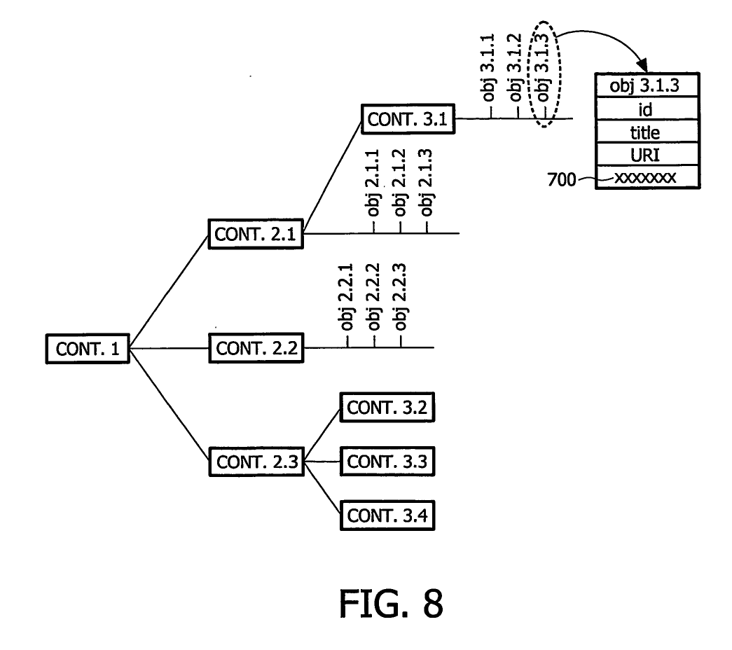

FIG. 8 shows an example structure of a content directory service (CDS).

Before describing the invention in detail, a conventional UPnP system will be briefly described. A more thorough explanation can be obtained from “UPnP AV Architecture” published by the UPnP Forum. The main components of a UPnP AV system are a Control Point (CP) 20, a Media Server (MS) 50 and a Media Renderer (MR) 60. All of these are logical entities: a physical device may include only one of these entities (e.g. a Control Point in the form of a remote control) or, more commonly, a combination of several of these entities. As an example, a CD player comprises a user interface and control circuitry for operating the player (a Control Point), apparatus for reading digital content from an optical disk (a Media Server) and apparatus for converting the digital content into an audio signal for presentation to a user (a Media Renderer).

Media Server (MS) 50 includes a store 52 of media content. The content can include, for example, audio, video, still images or a combination of these. The Media Server also supports a Content Directory Service (CDS) 55 which catalogues the content in store 52. The CDS is hierarchically organised in a manner similar to a computer file system. A container (analogous to a folder or directory) can include a plurality of objects (analogous to a file) and containers that are hierarchically one level lower. The object includes an object description with an identifier and optionally metadata. The metadata may include properties such as object name, artist, composer, date created, size, etc. The object may also include the object content (item) or include a locator, such as a URI, for locating the content. An example CDS structure is shown in FIG. 14. Further functions of the Media Server 50 are a Connection Manager Service which is used to manage connections between the Media Server 50 and other devices, such as the Media Renderer 60. An optional AV Transport Service allows control of the playback of content, with features such as stop, pause, seek etc.

Media Renderer (MR) 60 is responsible for rendering (reproducing) media content which is received from a Media Server 50. Reproduction equipment 62 is shown with a display 63 and speaker 64 although the output can take many forms. Typically, the reproduction equipment 62 includes one or more decoders, digital to analog converter and amplifiers. The Media Renderer 60 also supports a Connection Manager Service 65 for establishing a new connection with a Media Server and Render Control 61 for controlling the way in which the content is rendered. For audio reproduction this can include features such as a volume control.

Control Point (CP) 20 coordinates operation of the Media Server 50 and Media Renderer 60 and includes a user interface (UI) 21 by which a user can select content. The Control Point 20 supports the conventional UPnP mechanisms for discovering new devices and also supports mechanisms for finding the capabilities of Media Rendering devices and establishing connections between a Media Server and a Media Renderer. The UPnP AV Architecture supports a wide variety of AV devices such as TVs, VCRs, CD/DVD players/jukeboxes, set-top boxes, stereo systems, MP3 players, still-image cameras, camcorders, electronic picture frames (EPFs), and the PC. The AV Architecture allows devices to support different types of formats for the entertainment content (such as MPEG2, MPEG4, JPEG, MP3, Windows Media Architecture (WMA), bitmaps (BMP), NTSC, PAL, ATSC, etc.) and multiple types of transfer protocols (such as IEC-61883/IEEE-1394, HTTP GET, RTP, HTTP PUT/POST, TCP/IP, etc.).

Multiple physical devices, each having one or more or the CP, MS and MR entities, can be operated together as a network. FIG. 2 shows an example of a UPnP network which can represent a network of devices within a home. A Control Point 120, two Media Server devices 121, 122 and a Media Renderer device 140 are networked 110 together. The network 110 can be wired (e.g. Ethernet) or wireless (e.g. IEEE 802.11, Bluetooth). The media content can be wholly located on servers within the home network 100 or it can be located outside the home network 100. FIG. 2 shows a server 123 for storing content which is part of an external network 130, such as the Internet. This external server 123 is connected to the home network via a gateway 115.

Referring again to FIG. 1, this shows a conventional arrangement for accessing content over a UPnP network. The Media Server MS 50 maintains a Content Directory Service (CDS) 55 by interaction 31 with the local storage device 52. The Media Server 50 structures the CDS in a particular way, which may be dictated by the manufacturer of the MS. The CDS is updated as new content is added to the store 52. At some later time, a user interacts with user interface 21. Typically, the user interface 21 will present the user with a menu of possible options. As an example, an initial menu screen may ask the user whether they wish to retrieve audio content, video content or an image. In response to user selections at UI 21, the CP makes an appropriate query 32 of the CDS 55 of the MS 50. MS 50 responds with the required listing of content. When the user selects a piece of content, the CP instructs 33, 34 the MS and the MR to arrange an appropriate connection 35 and to begin streaming the content from the MS to the MR.

Referring again to FIG. 2, the network also includes a query caching service QCS 70, in accordance with the invention. The QCS is hosted by a device within the network and provides a service to any Control Point (CP) devices within the network which require it. FIG. 3 shows the operation of a first embodiment of a system in which a QCS is provided. For clarity, the Figure only shows one Control Point CP, a Media Server device MS-a and a device 75 hosting the QCS 70. FIG. 3 shows the message flows required for a CP to initiate creation of a cached query result. The MS maintains it's CDS 55 by interaction 201 with content storage 52, in a conventional manner. The CP instructs the QCS to create a cache of a particular query by sending a message 202. Message 202 specifies the query that is required to be cached. The QCS 70 queries the CDS 55 by message 203a and receives the results of the query in message 204a. Several queries 203a may be necessary to retrieve all of the required information. The results of the query are stored—cached—by the QCS 70. The QCS then sends the CP a message 205 which includes an identifying reference for the cached results which allows the CP to retrieve the results at a later time.

The CP can request the QCS to refresh a particular cached result at any time by sending a message to the QCS which specifies the reference of the cached query. In response to receiving the refresh message, the QCS performs a further query of the CDS and stores the updated results. The CP may send a refresh message in this manner because the CP thinks it might need to retrieve that particular result very soon, or because the QCS does not have it's own method of deciding when to refresh it's caches, or because the QCS has a policy which involves discarding any caches if they are not explicitly re-requested by the CP. In this case, only a confirmatory message that the refresh has occurred needs to be returned to the CP and not the actual result.

The CP can also ask the QCS for an update of a result that the CP already holds. In this case, the QCS sends the CP some representation of it's currently cached result, rather than re-performing the CDS query for itself. The QCS re-performs the query to produce a new set of results. There are several ways in which the QCS can respond. In order to minimise the amount of data which needs to be transmitted to the CP, it is preferred that the QCS compares the new results with the previous results and returns a message to the CP which indicates what modifications have been made to the result currently held by the CP. This further reduces the communication and processing demands on the CP as unchanged parts of the cache are not communicated. Alternatively, the QCS can provide a full listing of the cached result to the CP or it can simply store the new result until it is required.

FIG. 4 shows the message flows required for the QCS to initiate the creation of a cached query result. The QCS formulates a query and sends the query, as message 211, to the CDS. The result is sent as message 212 and is cached by the QCS. The QCS then informs the CP, by message 213, of the reference of the cached query and the query criteria to which it relates. As an example, message 213 can specify: “Cache reference: 105; Query criteria: the five most recently added items to CDS 55.” If, or when, the CP requires the relevant query, it can request this by sending a message 214 to the QCS, specifying the reference. The cached results are retrieved from storage by the QCS and sent to the CP as message 215.

Cached results can be deleted at the request of the CP or QCS. In the case of a CP initiated query, the CP can send a message to the QCS specifying the reference of the cached query that it wishes to delete.

FIG. 3 shows the CDS and QCS as separate devices. Indeed, they can each be hosted by a physically separate device. Alternatively, the CDS and QCS can be hosted by the same device, as shown by box 76 in FIG. 4, and communication between the CDS and QCS can be carried by internal channels rather than UPnP messages across the network.

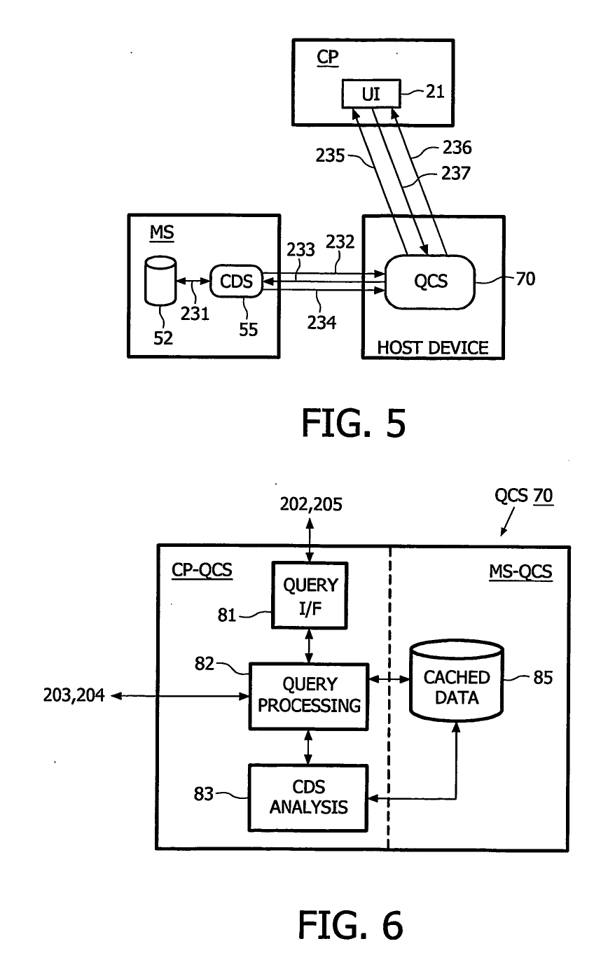

FIG. 5 shows the process for automatically updating the QCS in response to a change in the CDS. It is important that the cached results should be kept up-to-date to ensure the usefulness of the service. In a conventional manner, the MS maintains an up-to-date CDS whenever an update is made to the content of storage device 52. An update may occur when a new item is added, an existing item is deleted or a user decides to amend the content information or the position of an item within the structure of the CDS. The CDS informs the QCS when a change occurs to the content storage 52 by a standard UPnP message 232. In response to receiving message 232, the QCS determines which of the cached queries are likely to be affected by this update to the CDS. It submits a query 233, based on the original query criteria, to any changed parts of the CDS which are potentially relevant to currently cached queries. The QCS analyses the results 234 of the queries and updates each cached result, if necessary. The QCS can send a message 235 to the CP to indicate that the cached query has been updated, although this message is not essential. If, or when, the CP requires the results of the updated cache, it can request 236 and receive 237 it from the QCS. The QCS can use a similar mechanism (steps 233, 234) to actively confirm the validity of it's caches at any time. By providing an automatic update mechanism, the QCS can keep the cached results consistent with the CDS without further intervention by the CP, thus minimising traffic flows across the network.

FIG. 6 shows the main functional blocks within the QCS. A storage device 85 stores queries and the results of queries together with their references for retrieval. A query interface function 81 sends and receives messages to/from the CP. A query processing function 82 sends queries to MS devices, collates results from one or more MS devices and assigns references to cached data. In the embodiments where the QCS takes responsibility for deciding what queries to cache, the query processing function 82 formulates queries based on information received from the CP. CDS analysis function 83 is used when the QCS is informed of updates to CDSs. The analysis function 83 determines which of the cached queries are affected by the update and instructs the query processing function 82 to make further queries of the updated CDSs. Subsequently, the CDS analysis function 83 compares the updated results with the old results, stored in cache 85, and prepares an update message for sending to the CP if this is required.

The QCS can be hosted by one physical device 75. As the UPnP architecture does not allow a MS device to query another MS, the correct way of showing the QCS is as a MS device embedded within a CP device, as a CP device embedded within an MS device or as separate MS and CP devices which are able to co-operate closely, for example, because they are hosted by the same physical device. Thus, the storage function 85 is shown as part of a Media Server device, MS-QCS, which is embedded within a Control Point device, CP-QCS, which hosts the control functions 81, 82, 83.

FIG. 7 shows the main functional blocks within the CP. A User Interface processing unit 93 receives user inputs 96, such as selections made on a keyboard, by a mouse or on a touch sensitive screen, and issues outputs (not shown), such as graphical data for display on a screen and audible prompts. The processing unit 93 controls the generation of menus and responds to user selections in a known manner. User selections are logged by a database to form a collection of user selection statistics 92, representing historical information on a user's interaction with the UI. An analysis unit 91 analyses the user statistics 92 to determine the most commonly requested selections and menu navigations, to provide good candidates for queries to be cached. These are forwarded to the query processing unit 94. Information about the current state of the UI, i.e. the options currently presented, or shortly to be presented, to the user are similarly forwarded to the query processing unit as good candidates for caching. The selection of queries to cache can be based on a variety of criteria:
Basic queries, based on the functionality offered by the Control Point. These are queries which the basic structure of the UI almost guarantees will be encountered by the user at some point in their interaction (e.g. the first menu the user is presented with), regardless of their absolute frequency or how recently they were actually selected.
Commonly requested queries. Analysis of the user's past selection history, held by user statistics 92, will indicate what queries are regularly made. These are good candidates for caching.
Recently requested queries. Caching these will allow a user to quickly move backwards through the menu structure of the UI without the need to repeat each higher-level query.
Queries based on possible options presented to a user by the UI. At each stage of the operation of a UI, the user is presented with a range of possible options. A user is constrained to make one of the selections offered to them. Each available option can be queried and cached, the first X options can be queried and cached, or the most commonly selected options from that stage of the menu can be queried and cached, based on, for example, a users selection history at that stage of the menu. In each case, the queries are made and cached in advance of actual selection by a user in the hope that by the time a user makes a selection the results will be available with minimal delay to the user. In a more sophisticated form, queries be made for UI options one or more menu levels lower than the current menu level.
Probable query sequences based on selection statistics or other criteria. Predictions can be made’ for the route that a user will take through the menu structure of the UI.
Semantically similar queries or variations of the current query.

The query processing unit 94 can check whether a cache already exists for a query which is indicated as being a good candidate for caching. If a cache does not exist then the query processing unit can decide to request one from the QCS. If a request is made for a result which unit 94 knows has already been cached by the QCS, and which may shortly be needed, unit 94 can request the results from the QCS in advance of the actual selection by the user for storage in a short term cache on the CP. The extent to which the CP will cache in this way depends on the storage resources 95. Alternatively, unit 94 requests the results only when that menu selection is made.

Referring again to FIG. 4, this shows an embodiment where the QCS makes a decision of what should be cached. In order to make a decision of what needs to be cached, the QCS requires information about the UI of the CP. This can include information about the structure of a UI, i.e. the menu structure, what options a user is presented with, from which the QCS can derive queries to cache. Alternatively, or additionally, the information can take the form of information about user selections so that the QCS can compile it's own user selection statistics. The information can be sent by the CP on an ad hoc basis or in batches. Alternatively, the CP should be arranged to send details of the particular options currently presented to a user by the UI of the CP. Based on these, the QCS can determine what queries should be cached.

By storing the query results at the QCS, rather than on the Control Point, the storage and communication requirements for the Control Point are reduced. However, the amount of caching is constrained by the processing and storage resources of the QCS and by the resources of the MS hosting the CDS that is to be queried.

The reduced overhead for each caching operation allows the CP to request more queries to be cached on a speculative basis, thereby improving the chances of a relevant cache being available, and so improving the average response time of the system. This should also improve the operating performance of the UI. This is particularly important if the CP device is resource limited and connected to the network by a low bandwidth link, such as a wireless remote control unit.

For completeness, FIG. 8 shows an example structure of a Content Directory Service (CDS) of a MS. The CDS has a hierarchical structure of containers and objects. Containers hold multiple objects, e.g. a music album is a container holding multiple audio objects. As illustrated, containers can hold further sets of containers (as with container 2.3 holding containers 3.2, 3.3, 3.4) or multiple objects. Each object is defined by a number of properties. One such object, Object 3.1.3, is shown in more detail. In UPnP the properties must include an identifier such as an ‘id’ and ‘title’ (name). The object can include a Uniform Resource Identifier (URI) which points to the location of the media object. The object may be stored in the storage device within the Media Server (e.g. store 52 in FIG. 1) or in a server externally of the Media Server. A property of a container is a field which indicates whether the container can be searched. Further properties, including metadata 700, can also be included in the information.

1. A method of storing query information at a caching device in a system which uses a Content Directory Service (CDS) to store media content information, comprising:
querying the CDS of a serving device for media content information;
receiving the results of the query; and,
storing the results for later retrieval.

2. A method according to claim 1 further comprising the step of sending a querying device an identifier of the stored results for use in later retrieval.

3. A method according to claim 1 wherein the step of querying the CDS of a serving device uses a query received from a querying device.

4. A method according to claim 1 wherein the step of querying the CDS of a serving device uses a query formulated by the caching device.

5. A method according to claim 4 wherein the formulated query uses knowledge of the user interface of the querying device.

6. A method according to claim 5 wherein the formulated query uses knowledge of user selections at the user interface of the querying device.

7. A method according to claim 6 wherein the formulated query relates to a frequently selected option at the user interface.

8. A method according to claim 1 further comprising the steps of receiving notification from the serving device of an update to the CDS and updating the results stored at the caching device.

9. A method according to claim 8 wherein, upon receiving notification of an update to the CDS, the caching device is arranged to determine whether the stored results require updating.

10. A method according to claim 8 wherein, in the event that the stored information is updated, the caching device notifies the querying device that an update has occurred.

11. A method according to claim 10 wherein, in the event that the stored information is updated, the caching device sends the querying device the information that has changed.

12. A method of operating a querying device in a system which uses a Content Directory Service (CDS) to store media content information, comprising:
determining a candidate query that should be cached; and,
instructing a caching device to perform the candidate query and to store the results of the query.

13. A method according to claim 12 further comprising receiving an identifier of the stored results from the caching device for use in later retrieval of the stored results.

14. A method according to claim 12 wherein the querying device has a user interface and the step of determining a candidate query uses historical data of user selections at the user interface.

15. A method according to claim 14 wherein the candidate query is a frequently selected option at the user interface.

16. A method according to claim 13 wherein the candidate query is at least one option currently available to a user of the user interface, but not yet selected by the user.

17. Software for causing a processor to perform the method according to claim 1.

18. Control apparatus for a caching device for causing the caching device to perform the method according to claim 1.

19. A caching device incorporating the control apparatus according to claim 18.

20. Control apparatus for a querying device for causing the querying device to perform the method according to claim 12.

21. A querying device incorporating the control apparatus according to claim 20.

22. A method, software, control apparatus, caching device or querying device according to claim 1 for use in a system which conforms to Universal Plug and Play (UPnP).
